(19) United States
(12) Patent Application Publication
(10) Pub. No.: US 2020/0172444 A1
(43) Pub. Date: Jun. 4, 2020

(54) Slip And Process For The Production Of Ceramic And Glass Ceramic 3D Structures

(71) Applicant: Ivoclar Vivadent AG, Schaan (LI)

(72) Inventors: Lorenz Josef Bonderer, Sargans (CH); Jürgen Rudolf Laubersheimer, Buchs (CH); Wolfgang Josef Wachter, Schaan (LI); Christian Ritzberger, Grabs (CH); Michael Zenou, Hasmonaim (IL)

(21) Appl. No.: 16/657,078

(22) Filed: Oct. 18, 2019

(30) Foreign Application Priority Data
Nov. 29, 2018 (EP) 18209278.3

(51) Int. Cl. C04B 35/626; C04B 35/106; C04B 35/447; C04B 35/634; C04B 35/636; B28B 1/00

(52) U.S. Cl. CPC C04B 35/6264; C04B 35/106; C04B 35/447; C04B 35/63416; C04B 2235/665; C04B 35/6365; B28B 1/001; C04B 2235/3217; C04B 2235/3244; C04B 35/63424

(57) ABSTRACT

Slip for the production of ceramic or glass ceramic shaped parts by a LIFT process, which contains (a) ceramic and/or glass ceramic particles, (b) binder, (c) at least one energy transformation component and (d) at least one dispersant, as well as a LIFT process for the production of ceramic or glass ceramic shaped parts using the slip.

### CROSS-REFERENCE TO RELATED APPLICATIONS

This application claims priority to European Patent Application

No. 18209278.3 filed on Nov. 29, 2018, the disclosure of which is incorporated herein by reference in its entirety.

### TECHNICAL FIELD

The present invention relates to slips and processes for the production of ceramic or glass ceramic shaped parts, such as dental inlays, onlays, veneers, crowns, bridges and frameworks.

### BACKGROUND

The term “Additive Manufacturing” (AM) combines additive manufacturing processes in which 3-dimensional models or components are produced from computer-aided design data (CAD data) (A. Gebhardt, Vision of Rapid Prototyping, Ber. DGK 83 (2006) 7-12). These are processes, such as e.g. stereolithography (SL), selective laser sintering (SLS), 3D printing, fused deposition modelling (FDM), inkjet printing (IJP), 3D plotting, multi-jet modelling (MJM), solid freeform fabrication (SFF), laminated object manufacturing (LOM), laser powder forming (LPF), and direct ceramic jet printing (DCJP), with which models, components or shaped parts can be produced cost-effectively even on a small scale (A. Gebhardt, Generative Fertigungsverfahren, 3^{rd} ed., Carl Hanser Verlag, Munich 2007, 77 et seq.). Stereolithography is an AM process (A. Beil, Fertigung von Mikro-Bauteilen mittels Stereolithographie, Dusseldorf 2002, VDI-Verlag 3 et seq.), in which a shaped part is built up in layers from a liquid and curable monomer resin on the basis of CAD data. Stereolithographic processes for the production of dental shaped bodies, such as inlays, crowns or bridges, are advantageous mainly in the case of ceramic materials because the moulding and casting processes or the milling and grinding operations performed in the dental laboratory with considerable manual effort can thereby be made much easier and at the same time the large material loss occurring in the case of non-additive processes can be avoided. As a complete digital process chain is established nowadays, the conventional process steps for the production of e.g. multi-unit bridge frameworks (positioning in the articulator, wax modulation, investment and casting) can be replaced by the digitization of the model, virtual design of the dental shaped body and the additive stereolithographic manufacture thereof.

In the stereolithographic production of ceramic shaped parts, first of all a ceramic green compact is produced by layered radiation curing of a flowable ceramic slip, which is then sintered after debinding to form a dense ceramic shaped body. The green compact is also called a green body. Expelling the binder is referred to as debinding. Here the binder used is usually removed by heating the green compact to a temperature of approx. 80° C. to 600° C. It is important that the development of cracks and deformations is avoided to the greatest possible extent. The debinding turns the green compact into the so-called white body. In the debinding, the binder is broken down into volatile components by thermal and thermo-chemical processes.

The debinding is a critical step of the process. Here the danger that the component will be damaged by gases which form during the decomposition of the organic matrix and by the pressure exerted by these gases is great. The danger that during debinding small defects between the individual structural layers will lead to cracks or even to the complete destruction of the component is particularly great. This risk can be reduced by increasing the debinding time but this greatly lengthens the processing time.

The sintering of the white body is effected in a sintering furnace in a high-temperature firing. This results in the densification and solidification of the finely distributed ceramic powder through the effect of temperature below the melting temperature of the main components, whereby the porous component becomes smaller and its strength increases.

U.S. Pat. No. 5,496,682, which is hereby incorporated by reference, discloses light-curable compositions for the production of three-dimensional bodies by stereolithography, which contain 40 to 70 vol.-% ceramic or metal particles, 10 to 35 wt.-% monomer, 1 to 10 wt.-% photoinitiator, 1 to 10 wt.-% dispersant and preferably also solvents, plasticizers and coupling agents.

U.S. Pat. No. 6,117,612, which is hereby incorporated by reference, describes resins for the stereolithographic production of sintered ceramic or metal parts. The resins have a viscosity of less than 3000 mPa·s. For the production thereof, monomers with a low viscosity are used, preferably in aqueous solution. Through the use of dispersants, a high solids content, accompanied by a low viscosity, is to be achieved.

DE 10 2005 058 116 A1 discloses suspensions for the stereolithographic production of ceramic implants in the manner described in U.S. Pat. No. 6,117,612, which is hereby incorporated by reference, which contain no diluents such as water or organic solvents since these are believed to increase the viscosity through local evaporation when energy is introduced. The viscosity of the suspension is set to less than 20 Pa·s by varying the concentration of a dispersant. Alkylammonium salts of copolymers with acid groups are used as dispersant, wherein these can also be coated onto the particles of the ceramic powder.

In US 2005/0090575 A1, which is hereby incorporated by reference, methods and compositions for the stereolithographic production of ceramic components are described. It is stated that shaped parts produced with the liquid materials known from U.S. Pat. No. 5,496,682, which is hereby incorporated by reference, are soft and therefore require an additional curing step in order to prevent deformations during firing, while shaped bodies obtained from paste-like materials develop internal stresses during debinding, which lead to cracks during sintering. To avoid these problems, plasticizers are used and the quantity of ceramic powder is chosen such that the viscosity of the compositions is at least 10,000 Pa·s.

EP 2 151 214 A1 and corresponding U.S. Pat. No. 7,927,538, which is hereby incorporated by reference, discloses light-curing slips for the stereolithographic production of ceramic and glass ceramic shaped parts based on radically polymerizable binder, polymerization initiator and filler. Polymerization and polyaddition resins which consist of a mixture of low-molecular-weight or oligomeric monomers with one or more polyreactive groups are preferred as polyreactive binder. Surface-modified ceramic and/or glass ceramic particles are used as fillers.

In stereolithography, the materials to be printed have to be flowable and photoreactive during processing in order to make short exposure and processing times possible. In 3D inkjet printing the viscosity of the slips to be printed has to be significantly below 1 Pa·s, wherein a viscosity of less than 0.1 Pa·s is preferred.

The viscosity requirements rule out higher-viscosity materials and suspensions with a high filler content. A further disadvantage of ceramic slips for use in these processes is that in the liquid state they have a tendency for separation and sedimentation when left to stand for longer periods, i.e. the particles dispersed in the slip are deposited prematurely. On the other hand, materials with a high filler content and thus high viscosity are preferred because a high filler loading has a positive effect on the debinding and sintering, and stabilizes and shortens this process. The sedimentation stability is also improved.

From EP 2 233 449 A1 and corresponding U.S. Pat. No. 8,133,831, which is hereby incorporated by reference, slips for the production of ceramic shaped parts by hot melt inkjet printing processes are known, which contain ceramic particles, wax and at least one radically polymerizable wax, and which yield green bodies which can be debinded without the formation of cracks. In hot melt inkjet processes the slips are present in liquid form only during the printing process, i.e. for a relatively short period, whereby the danger of separation is reduced.

In stereolithographic processes, as high as possible a proportion by volume of ceramic particles in the slip is sought. However, the high viscosity caused by this is disadvantageous in respect of the printability of the materials. In addition, slips for stereolithographic processes are to have high reactivity in order thus to make short exposure and processing times possible.

Furthermore, a good green body strength and good dimensional stability, and high accuracy and precision after debinding, sintering and final cleaning of the bodies are to be ensured.

EP 1 268 211 B1 and corresponding U.S. Pat. No. 7,137,697, which is hereby incorporated by reference, disclose a printing process in which a change in volume or position in the material to be printed is induced locally by a focused laser beam, with the result that an ink droplet detaches from the substantially homogeneous ink layer and is transferred onto the printing substrate. This process is called a laser induced forward transfer (LIFT) process. The material to be printed is transferred from the so-called donor or carrier substrate onto the receiver substrate (acceptor). The carrier substrate consists of a carrier which is coated with a thin layer of the material to be printed. This material layer is irradiated in a punctiform manner with a laser and thereby softened or melted and partially evaporated. In the case of transparent carriers the laser can be focused from the back through the carrier onto the material to be printed. If the carrier is not transparent, the carrier is heated by the laser and the material is indirectly softened or melted. Alternatively, the laser can be directed onto the material directly from above. The receiver substrate (printing substrate) is arranged at a short distance from the carrier substrate, which is to be maintained precisely. A part of the material to be printed is evaporated abruptly by the laser energy. The vapour cloud forming entrains a small quantity of the softened or melted material and deposits it on the receiver substrate.

In order to evaporate the material to be printed the laser light must be absorbed and converted into heat. In the case of printing inks the laser beam is usually absorbed by ink pigments which are contained in the inks. Alternatively, an absorption layer can be provided which absorbs the laser light and then transfers the energy to the material to be printed. Such an absorption layer is usually arranged between the carrier and the material to be printed. Absorption layers are disadvantageous because parts of this layer are often transferred onto the receiver substrate together with the printing ink.

The production of ceramic or (glass) ceramic shaped parts by LIFT processes is not known.

### Summary

The known slips and processes are not ideal in respect of the requirements named above. The object of the invention is therefore to provide processes and slips for the production of ceramic and glass ceramic shaped parts by additive manufacturing (AM) which satisfy the above requirements and which do not have the named disadvantages. The slips are to be suitable in particular for LIFT processes and to be sedimentation-stable in the liquid state during the process. Slips and processes are to yield green compacts with high green density and strength, which can be debinded without deformation or the formation of cracks or stresses. When sintered the green compacts are to lead to high-strength ceramics which are suitable for dental purposes. In addition, different materials are to be able to be processed together to form one object.

### DETAILED DESCRIPTION

This object is achieved according to the invention by slips which contain
(a) ceramic and/or glass ceramic particles,
(b) preferably at least one binder,
(c) at least one energy transformation component and
(d) at least one dispersant.

This object is furthermore achieved by an additive process for producing three-dimensional objects, which preferably comprises the following steps:
(1) laminar application of the slip to a carrier in a defined layer thickness, preferably in a layer thickness of 3- 300 μm, particularly preferably 10-100 μm,
(2) transfer of a portion of the slip from the carrier substrate (donor) onto a receiver substrate (acceptor) by the local, site-selective input of an energy pulse, preferably a laser pulse,
(3) solidification of the slip on the receiver substrate, preferably by drying, radiation curing or altering the aggregation state (e.g. by temperature change),
(4) repetition of steps (1)-(3) in order to obtain a green compact,
(5) optionally removal of the support material from the green compact and optional cleaning of the green compact,
(6) optional post-curing of the green compact by further curing, preferably by drying, radiation, heat or a combination thereof,
(7) heat treatment of the green compact to remove the non-ceramic constituents, in particular the binder (debinding), in order to obtain a white body, and sintering of the white body to form a ceramic object,
(8) optional mechanical processing of the object, e.g. by vibratory finishing or manual processing such as grinding and/or polishing.

Steps (1) to (3) are repeated until the desired green body is completed. According to a preferred embodiment the slip is smoothed following step (3), preferably with a roller, blade, burr and/or a wiper. The green body is then processed further in steps (5) to (8), wherein steps (5), (6) and (8) are optional.

One or more different slips can be used in the process.

The slip or slips can be processed together with a support material. The support material is removed from the finished object. This can be effected either in a separate process step (5) or during the debinding or sintering in step (7). Slip and support material are also called printing materials herein.

In step (6) any uncured portions of the binder present are cured, preferably by irradiation with light, particularly preferably with visible or UV light. This form of after-treatment comes into consideration in particular when the binder is cured in step (3) by irradiation with light, preferably with visible or UV light.

Preferred carriers in step (1) are polymer films, preferably with a thickness of 10-200 μm, in particular PET, polyimide and polyvinyl chloride (PVC) films; glass carriers, preferably made of float glass or borosilicate glass; carriers made of non-metallic, inorganic, porous or non-porous materials; metallic carriers, preferably made of stainless steel, aluminium, titanium alloys, copper alloys such as bronze or brass; carriers made of non-metallic, inorganic materials such as ceramic carriers, preferably made of ZrO₂, Al₂O₃, zirconia-toughened alumina (ZTA), alumina-toughened zirconia (ATZ), SiCₓ, SiNₓ, diamond-like carbon, glassy carbon, BN, B₄C or AlN; or carriers made of a combination of these materials. The carriers are chosen such that they behave sufficiently inertly vis-a-vis the slip, i.e. in particular are not perceptibly swollen or attacked by the dispersant within the application time.

The carrier can be present as a plate, single-use tape, endless tape, cylinder or hollow cylinder. The work surface can be flat or curved. Curved surfaces are preferably curved about an axis, like e.g. the lateral surface of a cylinder.

In order to support the formation of homogeneous layers of the slip and optionally of the support material, slip, support material and carrier are preferably matched to each other. A low interfacial tension between slip or support material and carrier is sought.

Hydrophilic carrier and/or receiver substrates are preferably used for hydrophilic slips and support materials, for example glass carriers, cellophane or hydrophilic PET films.

Surfaces can be hydrophilized e.g. by flame, plasma or etching treatments. In general, slip and support material are to wet the carrier well. The wetting can likewise be improved by the addition of a surfactant to the slip and the support material. In the case of hydrophobic slips and support materials hydrophobic carriers are preferred.

The slip can be applied to the carrier in a known manner, preferably by scraper or doctor-blade systems, with slot nozzles (with or without dispenser), by flexographic or gravure printing, screen printing, pad printing, spray coating or by a combination of these processes. In general all the printing methods known in the state of the art are suitable for this. The coated carrier is also called carrier substrate herein.

In the case of printing cylinders the slip and optionally the support material is preferably deposited continuously onto a rotating cylinder. Through the rotation the layer of the material formed on the cylinder is transported in the direction of the energy source, e.g. the laser, and printed there. The printed material is then added to again during further rotation.

Carrier films can likewise be used in continuous processes, for example by forming them as a circulating tape. However, the coated films can also be ready-made for single use.

In step (2) a part of the energy introduced is absorbed by the slip and converted into heat. The absorption preferably takes place in the slip itself without an additional absorption layer on the carrier substrate, with the result that the disadvantages associated with such absorption layers are avoided.

The energy absorption brings about a local, abrupt volume expansion, for example by evaporation, of the dispersant in the material and leads to the detachment of the slip from the carrier substrate and to the transfer onto the receiver substrate. Droplets of the slip are transferred onto the receiver substrate, where they can coalesce and form, for example, a homogeneous film. The energy input in step (2) is preferably effected via the side of the carrier substrate facing away from the slip.

The receiver substrate can have a flat surface and should be at least large enough to accommodate the whole of the component to be printed. The receiver substrate preferably has a smooth surface, which can be closed or porous. By a porous surface is meant a surface which has pores with an average size of preferably 1 nm-10 μm. The pore size is determined using scanning electron microscopy by counting. The average values obtained in the process are specified.

Examples of materials with a micro- or nanoporous surface are set, dry gypsum, partially sintered but still porous ZrO₂, nanoporous glass or microporous plastics, such as e.g. high-density polyethylene sintered together.

The use of porous receiver substrates can promote the drying of the printing materials, particularly those printing materials that contain solid particles, such as slips for the production of ceramic objects. In particular when the solidification takes place through drying, a separate drying step can be omitted. However, it is to be ensured that the pores are smaller than the solid filler particles so that they do not clog the pores during the drying.

Together with the slip or slips, one or more support materials can be printed. By support materials is meant materials which are removed from the finished object. The slips remain after the removal of the support material and form the desired object.

Meltable support materials which combust residue-free and which melt and are removed during debinding and/or which are burnt up during sintering are preferred. Alternatively, the support material can also be removed before the debinding and sintering process e.g. by dissolving, melting, washing off or a combination thereof.

The desired three-dimensional objects are produced by repeated layered printing of slip and optionally support material. The individual layers can be formed by the support material alone, by the slip alone or by both materials together. Continuous layers which are formed exclusively by the support material are by nature arranged such that they lie outside the finished object, i.e. for example on top of or underneath the object.

Slip and support material can be printed together in one work step or one after another. For example, in a first work step a support material can be printed and then the slip can be printed in or on the solidified support structure in the described manner. The deposited layer thicknesses of the support material and of the slip can be different. It can thereby become necessary, e.g., for the number of deposited layers to be different for slip and for support material. According to a preferred embodiment several layers of the support material are first deposited on the receiver substrate.

Then the desired object is formed by printing at least one slip. Once the actual component has been completed, further layers of the support material can be applied, with the result that the top and bottom side of the printed object are delimited by one or more layers of the support material. In a particularly preferred embodiment the outer edge around the construction object in each layer is formed by the support material, with the result that the printed object is surrounded on all sides by support material.

Thicker layers can be used in areas of the component in which the cross section does not change greatly, while thinner layers are preferred at points in which the component cross section changes rapidly.

In preparation for the next depositing cycle, the applied material layer can optionally be smoothed in a further process step, for example with a metal roller, a blade, a wiper or a burr with/without material suction.

The layered application is continued until the desired three-dimensional object is completed. The printing process is controlled by a computer using CAD data, as is usual in additive manufacturing processes. The slip is used in the areas which form the shaped part and the support material is used underneath overhangs, to the sides of the component and in cavities.

In a preferred embodiment of the process the printing material, i.e. slip or support material, is applied to the carrier during the printing process. Alternatively, substrates already coated in advance can also be used, preferably in the form of coated carrier films. New printing material for the LIFT process is preferably provided by renewed, selective or continuous coating of the carrier substrate.

The process according to the invention is preferably a LIFT process. By a LIFT process is meant here a process in which, as explained at the beginning, a small quantity of material is extracted from a printing material by an energy pulse and transferred onto a receiver substrate. The energy pulse is preferably produced by a laser. The laser beam is focused onto a small area of the slip or support material and the printing material is hereby heated locally so strongly that at least one constituent of the slip expands abruptly. This constituent is also called volume expansion component and according to the invention corresponds to the dispersant. The energy transformation component absorbs the laser energy and transfers this to the slip or the support material. The abruptly evaporating volume expansion component entrains the slip or the support material and transfers it onto the receiver substrate. It is also possible for the volume expansion component to absorb a part of the energy directly.

According to the invention, instead of a laser beam, another suitable energy source can be used, for example focused light (not laser) or particle beams such as electron or ion beams. For the sake of simplicity the term LIFT process is also used here for processes in which no laser is used. Lasers are preferred, in particular lasers with a wavelength of from 300 nm to 4000 nm, for example neodymium:YAG lasers with a wavelength of 1064 nm. Pulsed laser light with a pulse energy in the μJ range and a pulse duration of from 1 ns to 1 ps is particularly preferred.

The slips used according to the invention in the LIFT process preferably contain the following constituents.

Ceramic and/or glass ceramic powders which yield ceramic bodies with a desired strength after a thermal debinding and sintering process are suitable as ceramic and/or glass ceramic particles (a), for example oxide or glass ceramic particles, such as e.g. aluminium oxide, zirconium oxide or lithium disilicate particles. According to the invention, particles with a particle size of less than 20 μm are preferred, less than 10 μm being more preferred and less than 5 μm being most preferred. The particles are preferably present in the non-agglomerated form. Particles with a particle size of from 3 nm to 20 μm are particularly preferred, from 5 nm to 10 μm being more preferred and from 7 nm to 5 μm being most preferred.

Unless otherwise indicated, all particle sizes here are the average value (d₅₀ value) of the volume distribution, which is measured by dynamic light scattering for particles smaller than 5 micrometres and by static light scattering for particles larger than 5 micrometres. To measure the particle size the particles are suspended in a suitable liquid at a concentration of 0.1 wt.-%. If the particles are hydrolysis-resistant (e.g. ZrO₂, Al₂O₃, ZTA, ATZ), deionized water is used. The pH is adjusted with an acid or base such that it is at least 2, or better 3, pH units away from the isoelectric point (literature values) of the particles. The samples are treated with ultrasound before and during the measurement. In the case of hydrolysis-sensitive particles (e.g. lithium disilicate), a solvent is used which does not attack the particles, for example tripropylene glycol. In this case, the pH is not adapted. To improve the dispersibility a suitable surface modifier can be added, for example Solplus™D540 from Lubrizol.

The determination of the particle size is effected in particular with the static laser scattering (SLS) process according to ISO 13320:2009, e.g. using an LA-960 particle size analyzer from Horiba, or with the dynamic light scattering (DLS) process according to ISO 22412:2017, e.g. using a NANO-flex particle measurement device from Colloid Metrix.

By ceramics is meant inorganic materials which have a crystalline structure and are usually produced from corresponding powders. The production of the ceramic is preferably effected by sintering (sintered ceramic). Oxide ceramics are preferably obtained by sintering metal oxide powders, such as e.g. ZrO₂ or Al₂O₃. Moreover, oxide ceramics can also contain one or more crystal phases.

Ceramic particles based on ZrO₂ or Al₂O₃; particles based on ZrO₂ stabilized with CaO, Y₂O₃, La₂O₃, CeO₂ and/or MgO; particles based on other metal oxides or on ceramics which are produced from several oxides and are thus constructed from different crystalline oxide phases, preferably ZrO₂—Al₂O₃, ZrO₂ spinel, ZrO₂—Al₂O₃spinel, spinels of the AB₂O₄, AB₁₂O₁₉, AB₁₁O₁₈, AB₂O₄ type, wherein A is preferably an alkali metal or alkaline earth metal ion and B is a transition metal ion which has a higher oxidation state than A, are preferably used. Ceramic particles made of ZrO₂—Al₂O₃, ZrO₂ spinel, ZrO₂—Al₂O₃spinel or of ZrO₂—Al₂O₃ stabilized with CaO, Y₂O₃, La₂O₃, CeO₂ and/or MgO are quite particularly preferred.

In addition to the base oxide such as ZrO₂ or Al₂O₃, stabilized ceramics contain a stabilizer which is preferably selected from CaO, Y₂O₃, La₂O₃, CeO₂, MgO, Er₂O₃ and mixtures thereof. The stabilizer is preferably used in a quantity of from 2 to 14 mol.-%, relative to the mass of the stabilized ceramic. For stabilization of the tetragonal and/or cubic crystal structure, high-strength ZrO₂ ceramics contain preferably 2 to 12 mol.-%, particularly preferably 2 to 10 mol.-%, Y₂O₃ (yttrium oxide). This ZrO₂ ceramic is called Y-TZP (yttria-stabilized tetragonal zirconia polycrystal). Ceramic particles which contain only base oxide and stabilizer are particularly preferred.

In the final end product after the dense sintering, in the case of higher proportions of Y₂O₃ (>3 mol.-%), a crystal phase mixture is usually obtained, i.e. a mixture of tetragonal and cubic crystal phase. Tetragonal stabilized zirconium oxide is referred to as “partially stabilized zirconia” (PSZ). Cubic stabilized zirconium oxide is referred to as “fully stabilized zirconia”. In the case of proportions of from 2 to 3 mol.-% ZrO₂ the majority of the crystal phase is usually tetragonal. However, as the Y₂O₃ proportion rises, the proportion of the cubic crystal phase increases.

According to the invention slips which contain glass ceramic particles as component (a) are furthermore preferred. Glass ceramics are materials which are produced, usually from amorphous glasses, in particular silicate glasses, by controlled nucleation and crystallization and in which a glass phase and one or more crystal phases are present next to each other in the solid body. Both glass powders and glass ceramic powders can be used as the starting material for glass ceramics. Glass ceramic particles which contain leucite crystals are particularly preferred and those which contain lithium disilicate crystals are quite particularly preferred. These can advantageously be produced from lithium disilicate glass powder or lithium disilicate glass powders by thermal treatment (crystallization and sintering firing). Glass ceramics preferred according to the invention are described in detail in EP 1 505 041 A1, EP 2 261 184 A1, EP 2 377 830 A1 and EP 2 377 831 A1 and corresponding U.S. Pat. Nos. 8,536,078, 8,557,150, 8,778,075, 8,865,606, 9,249,048, 9,321,674, 9,326,835, and 9,956,146, which US patents are hereby incorporated by reference.

The optimum particle size of component (a) is dependent on the ceramic used. In the case of Al₂O₃ the size of the particles used as component (a) is preferably in the range of from 50 to 500 nm, particularly preferably between 75 and 200 nm; in the case of glass ceramic it is in the range of from 200 nm to 20 μm, particularly preferably in the range of from 500 nm to 10 μm, and most preferably in the range of from 1 to 5 μm; in the case of TZP-3Y zirconia it is in the range of from 3 to 500 nm, most preferably in the range of from 20 to 350 nm. The particle size is preferably chosen such that sedimentation-stable slips are obtained.

Furthermore, ceramic or glass ceramic particles with a particle size in the range of 10-200 nm can also be used as nanosols or organosols, i.e. as a dispersion of the nanoparticles in a suitable dispersant.

The ceramic or glass ceramic particles used as component (a) are preferably stained. For this purpose, the ceramic and/or glass ceramic particles are preferably mixed with one or more colorants (e).

The colorant (e) is preferably used in a quantity of from 0.00001 to 10 wt.-%, particularly preferably 0.0001 to 7 wt.-% and quite particularly preferably 0.001 to 5 wt.-%, relative to the mass of component (a).

The usual dyes or pigments are not suitable according to the invention as colorant since they are not sufficiently stable to survive the debinding or sintering process. According to the invention, reactive transition metal compounds which form chromophoric transition metal ions during the debinding of the ceramic green compact produced or during the sintering of the ceramic white body obtained therefrom are preferably used as component (e). Transition metal compounds preferred as colorant are in particular acetylacetonates or carboxylic acid salts of the elements iron, cerium, praseodymium, terbium, lanthanum, tungsten, osmium and manganese. The salts of the carboxylic acids acetic acid, propionic acid, butyric acid, 2-ethylhexylcarboxylic acid, stearic acid and palmitic acid are furthermore preferred. The corresponding Fe, Pr, Mn and Tb compounds, such as e.g. iron(III) acetate or acetylacetonate, manganese(III) acetate or acetylacetonate, praseodymium(III) acetate or acetylacetonate or terbium(III) acetate or acetylacetonate as well as the corresponding carboxylic acid salts, are particularly preferred.

The chromophoric components are preferably chosen such that tooth-coloured ceramic shaped parts are obtained after the debinding and sintering.

Further preferred colorants (e) are pigments, more preferably inorganic pigments, such as for example the oxides of Pr, Tb, Ce, Co, Ni, Cu, Bi, La, Nd, Sm, Eu, Gd, and in particular of Fe, Mn, Cr, Er. For staining the ceramic or glass ceramic powders, coloured doped spinel or ZrO₂ compounds of the AB₂O₄ or ZrO₂:X type can advantageously be used, wherein A is preferably an alkali metal or alkaline earth metal ion and B or X is a transition metal ion which has a higher oxidation state than A. The doped spinels and doped ZrO₂ pigments are particularly suitable for staining glass ceramic and in particular lithium disilicate glass ceramic. The chromophoric components are added in a quantity which is necessary in order to achieve the desired colouring. The type and quantity of the chromophoric component(s) are preferably chosen such that tooth-coloured ceramic shaped parts are obtained after the debinding and sintering. The colour impression is not definitively formed until during the sintering.

According to an alternative embodiment, the chromophoric components are already contained in the ceramic or glass ceramic particles. An example of this is ZrO₂ particles with 3 mol.-% Er₂O₃, ZrO₂ particles with 3 mol.-% Y₂O₃ and Fe₂O₃ (yellow), ZrO₂ particles with 3 mol.-% Y₂O₃ and Co₂O₃ (grey), ZrO₂ particles with 5 mol.-% Y₂O₃ and Fe₂O₃ (yellow) and ZrO₂ particles with 5 mol.-% Y₂O₃ and Co₂O₃ (grey).

Some coloured ceramic or glass ceramic powders suitable according to the invention are commercially available.

Red-stained particles based on ZrO₂ stabilized with Er₂O₃ are available from Tosoh under the name TZ-PX-389. These particles contain no Y₂O₃. The colour effect is primarily to be attributed to Er₂O₃. The proportion of Er₂O₃ is 9.2 wt.-% (or 5 mol.-%).

Particles based on ZrO₂ stabilized with 3 mol.-% Y₂O₃, which contain 0.15 wt.-% Fe₂O₃, have a yellow colour and a low translucence. Such particles are available from Tosoh under the name TZ-PX364.

Particles based on ZrO₂ stabilized with 5 mol.-% Y₂O₃, which contain 0.25 wt.-% Fe₂O₃, have a yellow colour and a high translucence. Such particles are available from Tosoh under the name TZ-PX590.

Particles based on ZrO₂ stabilized with 3 mol.-% Y₂O₃, which contain 0.04 wt.-% Co₂O₃, have a grey colour and a low translucence.

Particles based on ZrO₂ stabilized with 5 mol.-% Y₂O₃, which contain 0.04 wt.-% Co₂O₃, have a grey colour and a high translucence.

The translucence of ceramic particles based on ZrO₂ can be set by the Y₂O₃ content. Ceramics with 3 mol.-% (Tosoh TZ-PX-245), 4 mol.-(Tosoh TZ-PX-524), 4.25 mol.-% (Tosoh TZ-PX-551) and 5 mol.-% (Tosoh TZ-PX-430) Y₂O₃ are commercially available, wherein the translucence increases as the Y₂O₃ content rises.

To achieve the desired colour impression, it is also possible to use mixtures of differently stained ceramic or glass ceramic powders as component (a). For this purpose, differently coloured ceramic and/or glass ceramic particles or colorants are mixed with each other such that a slip with the desired colour is obtained, and this slip is then printed.

According to the invention, for the production of ceramic or glass ceramic shaped parts several differently coloured slips can also be used, which are not combined with each other until during the LIFT process, such that a body with the desired colouring is obtained. This procedure has the advantage that different colourings can be obtained within the body.

According to a preferred embodiment of the invention, the particles of component (a) are surface modified with suitable substances. Those compounds which are chemically bonded, i.e. by ionic or covalent bonds, to the surface of the ceramic or glass ceramic particles are preferably used for the surface modification. Compounds which have either acid groups or preferably silyl groups, preferably alkoxysilyl groups, are preferred. The particle surface can be partially or preferably completely covered with the modifier. The modifiers used according to the invention are preferably oligomeric or polymeric compounds.

According to the invention those compounds are particularly suitable which, in contrast to the so-called adhesion promoters or coupling reagents, contain groups reacting only with the particle surface but no radically polymerizable groups which form a covalent bond with the resin matrix. Such compounds are referred to here as non-polymerizable surface modifiers. These compounds have the advantage that no stable bond is formed between the cerami particle surface and the polymer matrix in the cured green compact, which simplifies the complete removal of the polymer portions in the debinding process.

Silanes, quite particularly propyltrimethoxysilane, phenyltri-methoxysilane, hexyltrimethoxysilane, octyltrimethoxysilane, trimethylchlorosilane, trimethylbromosilane, trimethylmethoxy-silane or hexamethyldisilazane, are suitable in particular as non-polymerizable surface modifiers.

Surface modifiers are optionally used in a quantity of from preferably 0.01 to 5 wt.-%, particularly preferably 0.1 to 2 wt.-% and quite particularly preferably 0.2 to 1.5 wt.-%, relative to the mass of the slip.

The slips according to the invention preferably contain a binder (b). The slips can contain, as binder (b), e.g. one or more radically polymerizable monomers, preferably at least one (meth)acrylate and/or (meth)acrylamide, preferably mono- or multifunctional (meth)acrylates or a mixture thereof. Materials which contain at least one multifunctional (meth)acrylate or a mixture of mono- and multifunctional (meth)acrylates as radically polymerizable monomer are particularly preferred. By monofunctional (meth)acrylates is meant compounds with one, by polyfunctional (meth)acrylates is meant compounds with two or more, preferably 2 to 6, radically polymerizable groups. Preferred binders of this type are described in EP 3 147 707 A1 in paragraphs [0036] to [0044]. It is also stated there that such binders preferably contain a photoinitiator.

However, according to the invention those slips which contain non-reactive binder, i.e. binder that is not radically polymerizable, are preferred. Unlike reactive binders, non-reactive binders do not form a covalent polymer network during curing. Because of this, the ceramic and/or glass ceramic particles (a) can move relative to each other and thus partially relieve stresses during drying and/or debinding.

Binders which are solid in pure form at 25° C. are preferred. During the drying process such binders solidify and ensure a better strength of the green body.

Preferred binders are cellulose derivatives such as methylcellulose (MC), hydroxyethyl cellulose (HEC), hydroxypropyl methylcellulose (HPMC) and hydroxybutyl methylcellulose (HBMC) as well as sodium carboxymethyl cellulose (NaCMC), as well as cellulose derivatives in accordance with the following Formula 1:

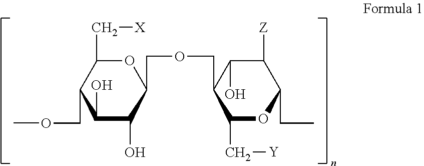

The variables of Formula 1 have the following meanings:
X —OH, preferably —OCH₃, —OC₂H₄OC₂H₄OH, —OC₃H₆OH, —OC₄H₈OH, —OCH₂COONa,
Y —OH, preferably —OCH₃, —OC₂H₄OH, —OCH₂COONa,
Z —OH, —OCH₃, —OC₂H₄OC₂H₄OH, preferably —OCH₃, —OC₂H₄OC₂H₄OH.

The degree of polymerization n results from the molecular weights defined below.

Preferred cellulose derivatives of Formula 1 are compounds in which the variables have the following meanings:
X=Y=Z=—OCH₃,
X=Z=—OC₂H₄OC₂H₄OH, Y =—OC₂H₄OH,
X=—OC₃H₆OH, Y=Z=—OCH₃,
X=—OC₄H₈OH, Y=Z=—OCH₃.

Other polysaccharides such as agar or amylopectin can also be used as binder but are less preferred.

Further preferred binders are poly(vinyl alcohol) (PVA), poly(vinyl acetate) (PVAc), poly(vinylpyrrolidine) (PVP), poly(acrylic acid) (PAA), copolymers of acrylic acid ester and acrylic acid (AE/AA), poly(ethyl acrylate) (PEA), poly(methacrylic acid) (PMAA), poly(methyl methacrylate) (PMMA), ammonium polyacrylate (NH₄PA), ammonium poly(methacrylate), poly(acrylamides), gelatin and poly(ethylene glycol) (HO—(CH₂CH₂O)ₙ—OH) and mixed polymers of ethylene glycol and propylene glycol, which have such a high molecular weight and/or such a high PEG proportion that they are solid at room temperature. The degree of polymerization n also results here from the molecular weights defined below.

Binders which have a molecular weight of from 1000 g/mol to 500,000 g/mol, preferably of from 3000 g/mol to 200,000 g/mol, more preferably of from 5000 g/mol to 100,000 g/mol, are preferred according to the invention.

In the case of poly(ethylene glycol), poly(propylene glycol) and mixed polymers of ethylene glycol and propylene glycol, the average molar mass Mw, which is calculated from the hydroxyl number measured according to ASTM D4274, is specified. Unless otherwise indicated, in the case of other polymers it is the molar mass Mn determined by viscometry (viscosity average) according to Ubbelohde.

Particularly preferred non-reactive binders (b) are poly(vinyl alcohol) (PVA) and poly(ethylene glycol) (PEG).

If the binder and the dispersant exhibit a strong interaction, such as e.g. in the case of polar binders and water, this interaction can cause the drying process to slow down, with the result that residues of the dispersant are still present after the drying. The drying kinetics can thus be matched to the process through the type and quantity of the binder.

Other binders, particularly the cellulose derivatives, yield slips with a marked shear-rate-dependent viscosity. This effect can be utilized to reduce the sedimentation of the particles during storage. During storage the shear rate is low. The consequence of this is a high viscosity and thus a slow sedimentation. During the printing process, the high shear rates occurring bring about a reduction in the viscosity, whereby a good processability is ensured.

The binder is preferably matched to the dispersant and the ceramic particles such that a homogeneous, stable suspension is obtained, i.e. that preferably no flocculation takes place. The stability of the suspension can be determined in accordance with E.J.W. Verwey, J.Th.G. Overbeek: Theory of the stability of lyophobic colloids, Elsevier, New York 1948.

The binder can be dispersed in the dispersant (d) in the form of small particles (so-called dispersion binders), but the binder (b) is preferably dissolved in the dispersant (d).

The energy transformation component (c) absorbs the bulk of the energy of the introduced energy pulse, for example of the incident laser beam, and converts it into heat. The thus-produced heat pulse is transferred onto the volume expansion component and leads to its abrupt expansion, for example to the abrupt formation of microscopic gas bubbles due to evaporation of the volume expansion component. The transfer of the slip from the carrier substrate onto the receiver substrate is induced hereby. The slip is deposited on the receiver substrate.

The energy transformation component (c) is tuned to the wavelength of the laser light to be absorbed. According to the invention inorganic and in particular organic dyes and pigments are preferred as energy transformation component. Dyes and colour pigments which can combust residue-free and which leave no residues behind on the final component after the debinding and sintering procedure are particularly preferred.

In particular dyes and pigments which absorb in the wavelength range of the radiation source used, preferably laser, are preferred. For example, for a neodymium: YAG laser with a wavelength of 1064 nm the following dyes/pigments are particularly preferred: Carbon Black, Sudan Black B (CAS 4197-25-5), Bismarck Brown Y (CAS 10114-58-6), 1-butyl-2-[2-[3-[(1-butyl-6-chlorobenz[cd]indol-2(1H)-ylidene)ethylidene]-2-chloro-1-cyclohexen-1-yl]ethenyl]-6-chlorobenz[cd]indolium tetrafluoroborate (CAS 155613-98-2) or Safranin 0 (CAS 477-73-6). Carbon Black, Sudan Black B (CAS 4197-25-5) and Safranin 0 (CAS 477-73-6) are particularly preferred.

For a green laser, e.g. with a wavelength of 532 nm, the following dyes/pigments are preferred: Carbon Black, Sudan Red 7B (Oil Violet CAS 6368-72-5), Sudan IV (CAS 85-83-6), Sudan Red G (CAS 1229-55-6), Pigment Red 144 (CAS 5280-78-4), Safranin O (CAS 477-73-6).

For a blue laser, e.g. with a wavelength of 405 nm, the following dyes/pigments are preferred: Carbon Black, Pigment Yellow 93 (CAS 5580-57-4), Sudan Yellow 146 (CAS 4314-14-1), Disperse Yellow 7 (CAS 6300-37-4).

The energy transfer component (c) is preferably a constituent of the slip and is not present on the carrier as an additional layer (absorption layer).

The function of the energy transformation component can be strengthened or even taken over by light scattering which is brought about by particles of the component (a) and/or of the colorant (e).

As dispersant (d), the slips according to the invention contain a liquid component, in which the ceramic and/or glass ceramic particles (a) are dispersed. Dispersants which are liquid in pure form at 25° C. are preferred. Preferred dispersants are organic solvents and in particular water.

A mixture of different liquids can be used as dispersant. The dispersant contains at least one low-boiling component and preferably additionally one or more high-boiling components.

According to the invention, by low-boiling components is meant solvents with a boiling point of less than 200° C. (under standard pressure). Suitable solvents are, for example, acetic acid butyl ester, acetic acid n-hexyl ester. Preferred low-boiling solvents are 1-octanol, propylene glycol diacetate, ethylene glycol diacetate, acetone, methyl ethyl ketone (MEK), isopropanol, ethanol, butanol, p-xylene, cyclohexanone, butyl acetate, pentyl acetate, hexyl acetate and particularly preferably water. Water has the advantage that no solvent vapours which are hazardous to health or potentially explosive form during the evaporation.

By high-boiling components is meant solvents with a boiling point of over 200° C. (under standard pressure). Preferred high-boiling solvents are liquid poly(ethylene glycols) with a molecular weight between 150 and 600 g/mol, propylene glycol, dipropylene glycol, tripropylene glycol, poly(propyl glycols) with a molecular weight of from 150 to 4000 g/mol, particularly preferably with a molecular weight of from 150 to 600 g/mol, the ethers thereof such as the methyl ether, ethyl ether, propyl ether, isopropyl ether, butyl ether, hexyl ether, either as monoethers or diethers; phthalates, such as dimethyl phthalate, diethyl phthalate, dibutyl phthalate; glycerol; dimethyl adipate, diethyl adipate, dipropyl adipate, dibutyl adipate or glutarates; diethyl succinate; acetyl tri-n-butyl citrate.

Polar high-boiling solvents such as PEG (average molecular weight <600 g/mol), glycerol and 1,2-propanediol are particularly suitable for combination with water.

According to the invention, the dispersant (c) has a dual function. On the one hand it serves as dispersant for component (a) and optionally as solvent for component (b), on the other hand it preferably also takes on the function of the volume expansion component, wherein this function is primarily taken on by the low-boiling component.

Additionally or alternatively, solid, homogeneously dispersed organic substances which decompose abruptly forming gases at a temperature of from 80° to 280° C., for example azobis(isobutyronitrile) (AIBN), can be used as volume expansion component. These dispersed organic substances can, alone or together with the lower-boiling component of the dispersant, bring about the volume expansion during the printing process.

The low-boiling component of the dispersant is evaporated off (dried) after the droplet transfer until the ceramic suspension solidifies to form a green body. The evaporation is preferably effected by a controlled airflow. Water is preferred as the main constituent of the dispersant because it gives off no poisonous, flammable vapours during drying. In the case of hydrolysis-sensitive particles, such as e.g. lithium disilicate particles, an inert organic solvent is preferably used which does not attack the particles.

In addition to the low-boiling component, the dispersant can contain a high-boiling component. This is only partially removed during drying. The majority of this component is not removed until during the debinding, by evaporation and/or by thermal decomposition.

High-boiling solvents can be admixed in order to optimize the drying and/or debinding kinetics. Mixtures of high- and low-boiling solvents evaporate at different temperatures and thus enable the process to be made gentler. Through the interaction with the remaining dispersant, the drying is slowed down, for example, and the risk of drying cracks forming is thus reduced.

Moreover, high-boiling solvents make it easier for the ceramic particles to slide against each other and thus make it possible to relieve stresses during the drying and/or debinding. In contrast to the binders, the high-boiling solvents are liquid in pure form at 25° C. The high-boiling component thus has the function of a plasticizer or drying control agent.

In addition to the above-named components, the slips according to the invention preferably also contain at least one additive, which is selected from stabilizers such as methylhydroquinone (MEHQ) and 2,6-di-tert-butyl-p-cresol (BHT), antimicrobial and/or fungicidal substances such as polyformaldehyde, parabens such as hydroxybenzoic acid methyl ester or the salts thereof, rheology modifiers such as modified fat derivatives, modified urea derivatives and fragrances such as 2-benzylideneheptanal (amyl cinnamaldehyde), ethyl 2-naphthyl ether and essential oils.

With the exception of the ceramic and/or glass ceramic particles (a) and of the colorants (e), all the substances found in the slip are removed during the debinding and sintering process. Those substances which form less than 0.1 wt.-% residues during debinding and sintering, relative to the ceramic phase, are preferred.

The slips according to the invention preferably have the following composition:

| | | | quite |
|---|---|---|---|
| | | particularly | particularly |
| Component | preferably | preferably | preferably |
| (Glass) ceramic | 35-90% | 50-88% | 60-85% |
| powder (a) | | | |
| Colorant (e) (% relative | 0.00001-30% | 0.0001-25% | 0.001-20% |
| to the (glass) | | | |
| ceramic powder) | | | |
| Binder (b) | 0-10% | 0.2-7% | 0.5%-5% |
| Energy transformation | 0.000-5% | 0.001-3% | 0.01-1.5% |
| component (c) | | | |
| Dispersant (d) | 9-50% | 11-40% | 14-30% |
| Lower-boiling | at least | at least | at least |
| portions of | 50% of the | 60% of the | 70% of the |
| the dispersant | dispersant | dispersant | dispersant |
| Additives | 0-15% | 0-10% | 0-5% |

Unless otherwise indicated, all data are in percent by weight and are relative to the total weight of the slip.

Slips preferred according to the invention are suspensions of zirconium oxide in a liquid medium which have a zirconium oxide content of from 68 to 88 wt.-%, preferably 70 to 86 wt.-% and more preferably 75 to 85 wt.-%.

The zirconium oxide in the suspension has in particular a particle size of from 50 to 250 nm, preferably of from 60 to 250 nm and more preferably 80 to 250 nm, measured as the d₅₀ value, relative to the volume of all particles. The determination of the particle size is effected in particular with the static laser scattering (SLS) process according to ISO 13320:2009, e.g. using an LA-960 particle size analyzer from Horiba, or with the dynamic light scattering (DLS) process according to ISO 22412:2017, e.g. using a NANO-flex particle measurement device from Colloid Metrix.

The primary particle size of the zirconium oxide lies in particular in the range of from 30 to 100 nm and it is usually likewise determined with a dynamic light scattering (DLS) process such as described above or by means of scanning electron microscopy.

The zirconium oxide is in particular zirconium oxide based on tetragonal zirconia polycrystal (TZP). Zirconium oxide which is stabilized with Y₂O₃, La₂O₃, CeO₂, MgO and/or CaO and in particular is stabilized with 2 to 14 mol.-%, preferably with 2 to 10 mol.-% and more preferably 2 to 8 mol.-%, of these oxides, relative to the zirconium oxide content, is preferred.

The zirconium oxide can also be stained. The desired staining is achieved in particular by adding one or more colouring elements to the zirconium oxide. The addition of colouring elements is sometimes also called doping and it is usually effected during the production of the zirconium oxide powder by co-precipitation and subsequent calcining. Examples of suitable colouring elements are Fe, Mn, Cr, Ni, Co, Pr, Ce, Eu, Gd, Nd, Yb, Tb, Er and Bi. The zirconium oxide in the suspension can also be a mixture of zirconium oxide powders with different compositions, leading in particular to a different colouring and/or translucence in the dental restoration ultimately produced. The desired colour can thus be set easily and in a targeted manner with the aid of a mixture of differently coloured zirconium oxide powders. In the same way, the translucence of the produced object can also be set in a targeted manner through the use of a mixture of zirconium oxide powders with different translucence. The degree of translucence of the produced object can be controlled in particular through the yttrium oxide content of the zirconium oxide powders used.

The suspension can also be a mixture of different suspensions with, for example, differently coloured zirconium oxide.

The zirconium oxide is present as a suspension in a liquid medium. This liquid medium contains preferably water. In addition, it is preferred if the liquid medium has only small quantities of organic components and therefore contains organic components in a quantity of preferably not more than 5 wt.-%, more preferably not more than 3 wt.-%, further preferably not more than 2 wt.-% and most preferably not more than 1 wt.-%, relative to the quantity of solid in the suspension.

In a further preferred embodiment the liquid medium contains organic components in a quantity of from 0.05 to 5 wt.-%, preferably 0.1 to 3 wt.-%, more preferably 0.1 to 2 wt.-% and most preferably 0.1 to 1 wt.-%, relative to the quantity of solid in the suspension.

In addition to the binder (b),dispersants, agents for setting the pH, stabilizers and/or defoamers are preferably used as organic components of the slip.

The dispersant serves to prevent the agglomeration of suspended particles to form larger particles. The quantity of dispersant in the liquid medium is in particular 0.01 to 5 wt.-%, preferably 0.1 to 2 wt.-% and particularly preferably 0.1 to 1 wt.-%, relative to the quantity of solid in the suspension.

Preferred dispersants for the slip are amino alcohols, such as ethanolamine, carboxylic acids, such as maleic acid and citric acid, and carboxylic acid salts, as well as mixtures of these dispersants. The slip preferably contains at least one dispersant, particularly preferably at least one compound selected from ethanolamine, citric acid and citric acid salt.

Further preferred dispersants are formic acid, acetic acid, propionic acid, octanoic acid, isobutyric acid, isovaleric acid, pivalic acid or phosphonic acids, e.g. such as methyl, ethyl, propyl, butyl, hexyl, octyl or phenyl phosphonic acid, acidic phosphoric esters, such as e.g. dimethyl, diethyl, dipropyl, dibutyl, dipentyl, dihexyl, dioctyl or di(2-ethylhexyl) phosphate and tetramethylammonium hydroxide and catechols or gallates ethoxylated or propoxylated 2 to 8 times.

The binder promotes the cohesion of particles in the green compact. The quantity of binder in the liquid medium is in particular 0 to 10 wt.-%, preferably 0.2 to 7 wt.-% and more preferably 0.5 to 5 wt.-%, relative to the quantity of solid in the suspension.

Acids and bases, such as carboxylic acids, e.g. 2-(2-methoxyethoxy)acetic acid and 2-[2-(2-methoxyethoxyethoxy]acetic acid, inorganic acids, e.g. hydrochloric acid and nitric acid, as well as ammonium hydroxide and tetramethylammonium hydroxide, are preferably used as agents for setting the pH and as stabilizers. Preferably the liquid medium contains tetramethylammonium hydroxide.

The defoamer serves to prevent air bubbles in the suspension. It is typically used in the liquid medium in a quantity of from 0.001 to 1 wt.-%, preferably 0.001 to 0.5 wt.-% and more preferably 0.001 to 0.1 wt.-%, relative to the quantity of solid in the suspension. Examples of suitable defoamers are paraffins, silicone oils, alkylpolysiloxanes, higher alcohols, in particular alkylpolyalkylene glycol ethers.

Because of the small proportion of organic components, these can also be burnt out of the blank within a short time.

To produce the suspension the zirconium oxide is typically intimately mixed with the liquid medium in powder form. Mixtures of for example differently coloured zirconium oxide can also be used. During this mixing, agglomerates (present) which are usually broken up and the zirconium oxide used can also be ground in order to produce the desired particle size. The mixing of zirconium oxide and liquid medium can therefore be carried out advantageously in agitator bead mills, for example.

The slips according to the invention preferably have a viscosity of from 0.01 Pas to 1000 Pas. Unless otherwise indicated, the viscosity is measured herein with an Anton Paar rheometer with CP50-1 cone-plate measuring equipment at a shear rate of 100/s and at the processing temperature. Unless otherwise indicated, the processing temperature is 25° C.

The slips can have a solid or paste-like consistency at room temperature (25° C.). This has the advantage that the slips have greater storage stability. In that case they are not melted until during the printing process, either by the energy pulse used for the transfer or in that the carrier is heated, preferably to approx. 50° C. The use of solid or paste-like slips is preferred particularly in the case of lithium disilicate slips.

The slips according to the invention are suitable in particular for the production of ceramic or glass ceramic shaped parts, in particular for the production of dental restorations, such as e.g. inlays, onlays, veneers, crowns, bridges, frameworks, abutments, brackets or implants.

The slips according to the invention are preferably printed together with a suitable support material. The support materials should preferably behave inertly in combination with the slips used. The slips are printed together, preferably sequentially, with the support material.

Support materials which contain no components which react with the slip used are preferred according to the invention. This would make it more difficult to remove the support materials from the shaped body. After the curing of the workpiece the support material is removed from the shaped body. In general, those support materials which contain exclusively organic components are preferred.

Support materials which contain
(α) at least one energy transformation component,
(β) at least one volume expansion component and
(γ) at least one binder are preferred.

Non-metallic substances which are solid in pure form at room temperature are suitable in particular as binder. The binder primarily carries out the support function.

The energy transformation component (a) in the support material is tuned to the wavelength of the laser light to be absorbed. According to the invention inorganic and in particular organic dyes and pigments are preferred as energy transformation component. Dyes and colour pigments which can combust residue-free and which leave no residues behind on the final component after the debinding/sintering procedure are particularly preferred.

In addition, dyes and pigments which absorb in the wavelength range of the radiation source used, preferably laser, are preferred. For example, for a neodymium:YAG laser with a wavelength of 1064 nm the following dyes/pigments are particularly preferred: Carbon Black, Sudan Black B (CAS 4197-25-5), Bismarck Brown Y (CAS 10114-58-6), 1-butyl-2-[2-[3-[(1-butyl-6-chlorobenz[cd]indol-2(1H)-ylidene)ethylidene]-2-chloro-l-cyclohexen-l-yl]ethenyl]-6-chlorobenz[cd]indolium tetrafluoroborate (CAS 155613-98-2) or Safranin 0 (CAS 477-73-6).

For a green laser, e.g. with a wavelength of 532 nm, the following dyes/pigments are preferred: Carbon Black, Sudan Red 7B (Oil Violet CAS 6368-72-5), Sudan IV (CAS 85-83-6), Sudan Red G (CAS 1229-55-6), Pigment Red 144 (CAS 5280-78-4), Safranin O (CAS 477-73-6).

For a blue laser, e.g. with a wavelength of 405 nm, the following dyes/pigments are preferred: Carbon Black, Pigment Yellow 93 (CAS 5580-57-4), Sudan Yellow 146 (CAS 4314-14-1), Disperse Yellow 7 (CAS 6300-37-4).

The volume expansion component (B) has the main purpose of bringing about a transfer of the printing material from the carrier substrate onto the receiver substrate. In order that the absorbed energy leads to a controlled droplet formation, the volume expansion component is to be converted into the gas phase in the shortest time due to the heat pulse. A substance with a boiling point of 80-280° C. and particularly preferably of 95-200° C. is preferably used as volume expansion component (boiling points at standard pressure). Preferred substances are 1,8-octanediol and 1,6-hexanediol. Substances which are liquid at 25° C., in particular water and 1-octanol, are particularly preferred. Water has the advantage that no solvent vapours which are hazardous to health or potentially explosive form during the evaporation.

Further preferred substances which can be used as volume expansion component (β) are propylene glycol diacetate, ethylene glycol diacetate, triethyl-2-acetyl citrate, triethyl citrate, adipic acid dimethyl ester, adipic acid diethyl ester, triethylene glycol, glutaric acid diethyl ester, glutaric acid dimethyl ester, diethyl succinate, acetic acid butyl ester, acetic acid n-hexyl ester. The volume expansion component is preferably matched to the binder used such that the viscosity, the surface tension and the homogeneity lie within the ranges defined herein. A homogeneity suitable according to the invention exists when there is no visible phase separation. For this, polar binders such as PEG, PVA are preferably combined with a polar volume expansion component such as e.g. water, and non-polar binders such as paraffin are preferably combined with a less polar volume expansion component such as 1-octanol.

Alternatively, solid, homogeneously dispersed organic substances which decompose abruptly into gases at temperatures of 80° -280° C., for example azobis(isobutyronitrile) (AIBN), can be used as volume expansion component (β).

Polymers, waxes and/or non-ionic surfactants are preferably used as binder (γ).

Polymers preferred according to the invention are glycol polymers, in particular polyethylene glycol (PEG), polypropylene glycol (PPG), PEG-PPG copolymers and PVA. Polyethylene glycol (PEG) with a molecular weight of 1500-10,000 g/mol is particularly preferred. Polymers such as polyacrylamide, polyvinylpyrrolidone, amylopectin, gelatin, cellulose, polymers based on polyacrylic acid and in particular copolymers of acrylic acid or sodium acrylate with acrylamide are further preferred. These polymers are polar and can form hydrogels. Polar polymers are particularly suitable for combination with a polar volume expansion component such as water.

In the present invention the term “wax” is to be understood as defined by the Deutsche Gesellschaft fü r Fettwissenschaft (German Society for Fat Science) in DGF standard method MI1 (75). As the chemical composition and origin of different waxes vary greatly, waxes are defined via their mechanical-physical properties. A substance is called a wax if it is kneadable, solid to brittle hard, has a coarse to fine-crystalline structure, is translucent to opaque in terms of colour but is not glassy at 20° C.; above 40° C. it melts without decomposition, is readily liquid even slightly above the melting point (low-viscosity) and not stringy; has a strongly temperature-dependent consistency and solubility, and can be polished under slight pressure. Waxes typically change into the molten state between 40° C. and 130° C.; as a rule waxes are insoluble in water. Waxes for use in the support material according to the invention preferably have a melting point in the range of from 40 to less than 80° C., particularly preferably of from 45 to 65° C.

Waxes are divided into three main groups depending on their origin, namely natural waxes, wherein here a distinction is in turn made between plant and animal waxes, mineral waxes and petrochemical waxes; chemically modified waxes and synthetic waxes. The wax used as binder in the support material according to the invention can consist of one wax type or also of mixtures of different wax types.

In the present invention petrochemical waxes, such as for instance paraffin wax (hard paraffin), petrolatum, microcrystalline wax (micro paraffin) and mixtures thereof are preferred, paraffin wax is particularly preferred. Paraffin waxes which are commercially available as injection-moulding binders for manufacturing oxide-ceramic and non-oxide-ceramic components in the hot-casting process (low-pressure injection moulding) are very suitable, e.g. paraffin wax with a melting point of approx. 54-56° C., a viscosity of 3-4 mPa·s at 80° C. Commercially available waxes often already contain emulsifiers and/or further components for adapting the rheology.

Plant waxes, e.g. candelilla wax, carnauba wax, Japan wax, esparto wax, cork wax, guaruma wax, rice bran wax, sugarcane wax, ouricury wax, montan wax; animal waxes, e.g. beeswax, shellac wax, spermaceti, lanolin (wool wax), rump fat; mineral waxes, e.g.

ceresin, ozokerite (earthwax); chemically modified waxes, e.g. montan ester waxes, sasol waxes, hydrogenated jojoba waxes; or synthetic waxes, e.g. polyalkylene waxes, polyethylene glycol waxes, can also be used as wax.

Non-ionic surfactants are substances with surface-active properties which do not form ions in aqueous media. These are molecules which have a hydrophobic portion and a hydrophilic portion. The overall hydrophobicity of the molecules can be set through the choice of the length and type of the hydrophobic and hydrophilic portions.

Support materials which contain a surfactant with a melting point of from 40° C. to 120° C., preferably 45° C. to 80° C., as non-ionic surfactant (γ) are preferred.

Preferred non-ionic surfactants are the ethoxylates of fatty alcohols, oxo alcohols or fatty acids, fatty acid esters of sugars and hydrogenated sugars, alkyl glycosides as well as block polymers of ethylene and propylene oxide, in particular short-chain block co-oligomers.

Fatty acid esters of hydrogenated sugars are particularly preferred, in particular those with the formula R′-CO-O-sugar, wherein R′ is a branched or preferably straight-chain alkyl radical with 10 to 25 carbon atoms, preferably 12 to 22 carbon atoms. Straight-chain alkyl radicals with 15 to 22 carbon atoms are preferred. “Sugar” stands for a hydrogenated sugar radical which is preferably ethoxylated 0 to 5 times. Fatty acid esters of sorbitol are quite particularly preferred, in particular sorbitan stearates such as e.g. sorbitan monostearate (CAS 1338-41-6).

A further preferred group of surfactants are ethoxylates of fatty acids, in particular those with the general formula R″—(CO)—(OCH₂CH₂)ₘ—OH, in which R″ is a branched or preferably straight-chain alkyl radical with 10 to 25 carbon atoms, preferably 12 to 22 carbon atoms. Straight-chain alkyl radicals with 16 to 22 carbon atoms are particularly preferred. m is an integer from 0 to 20, preferably 0 to 10 and particularly preferably 0 to 6.

Surfactants (γ) quite particularly preferred according to the invention are fatty alcohols and ethoxylates of fatty alcohols, in particular polyalkylene glycol ethers with the general formula R—(OCH₂CH₂)ₙ—OH, in which R is an alkyl radical with 10 to 20 carbon atoms and n is an integer from 0 to 25. R can be a branched or preferably straight-chain alkyl radical, wherein alkyl radicals with 12 to 25 carbon atoms and particularly straight-chain alkyl radicals with 12 to 22 carbon atoms are preferred. Quite particularly preferred alkyl radicals are lauryl, cetyl, cetearyl and stearyl. The polyalkylene glycol ethers can be obtained by reacting the corresponding fatty alcohols with ethylene oxide (EO). The index n indicates the number of ethylene oxide radicals. Polyalkylene glycol ethers with 0 to 21 (n=2-21), in particular 0 to 12 (n=2-12) and quite particularly 0 to 5 (n=2-5) ethylene oxide radicals are preferred. Examples of polyalkylene glycol ethers preferred according to the invention are compounds in which R is a cetyl radical (C₁₆ radical) and n is 20 and in particular 2. These compounds have the INCI names Ceteth-2 and Ceteth-20. Ceteth-2 has e.g. the formula C₁₆H₃₃—(OCH₂CH₂)₂—OH. Compounds in which R is a stearyl radical (C₁₈ radical) and n is 2, 10, 20 or are further preferred. These compounds have the INCI names Steareth-2, Steareth-10, Steareth-20 and Steareth-21. Steareth-2 has e.g. the formula C₁₈H₃₇—(OCH₂CH₂)₂—OH. Quite particularly preferred non-ionic surfactants are Steareth-20, Steareth-10, Ceteth-20 and in particular Steareth-2 and Ceteth-2. Mixtures of different non-ionic surfactants and in particular different polyalkylene glycol ethers can likewise be used.

Binders (γ) with a melting point between 40° C. and 200° C., particularly preferably 50° C. to 80° C., are preferred, wherein those binders which do not decompose thermally during melting are particularly preferred. In the melted state the binder preferably has a viscosity of below 100 Pas, particularly preferably below 20 Pas and quite particularly preferably below 5 Pas, so that it can be easily removed from the component. The binder should be combustible as residue-free as possible. It is important that the support material in the solid state has a sufficient strength to be able to support the printing material correspondingly.

The support materials according to the invention can additionally contain one or more further surfactants to set the surface tension and to set the interfacial tension between support material and carrier, between support material and receiver and between support material and construction material. Through the setting of surface tension and interfacial tension it is ensured that the layer of the support material applied to the carrier does not contract (bulging effect), that it forms a homogeneous layer on the receiver and that the construction material does not contract on the support material (bulging effect). Preferred surfactants for setting the surface tension and interfacial tension are ionic surfactants (e.g. stearic acid), amphoteric surfactants (e.g. N,N,N-trimethylammonioacetate) and preferably the above-named non-ionic surfactants, wherein fatty alcohol ethoxylates (FAEO) and polyalkylene glycol ethers are particularly preferred here. In addition to the interface-adapting function, certain surfactants, particularly the above-defined non-ionic surfactants, also have a support function.

The support materials preferred according to the invention preferably have a viscosity of from 0.2 Pas to 1000 Pas and a surface tension of from 20 to 150 mN/m, preferably 30 to 100 mN/m and particularly preferably 40 to 90 mN/m.

Unless otherwise indicated, the viscosity of the support materials is measured with an Anton Paar rheometer with CP50-1 cone-plate measuring equipment at a shear rate of 100/s and at a temperature of 25° C.

The support materials preferred according to the invention can preferably contain one or more additives in addition to the named substances. Preferred additives are stabilizers such as methylhydroquinone (MEHQ) and 2,6-di-tert-butyl-p-cresol (BHT); rheology modifiers such as polyvinyl alcohol, hydroxyethyl cellulose, carboxymethyl cellulose, polyvinylpyrrolidone; fragrances, such as 2-benzylideneheptanal (amyl cinnamaldehyde), ethyl 2-naphthyl ether and essential oils; and fillers. Organic fillers which combust residue-free are preferred. Furthermore, antimicrobial substances such as polyformaldehyde, parabens such as hydroxybenzoic acid methyl ester come into consideration as additives.

The support materials preferred according to the invention preferably contain:

0.05 to 30 wt.-%, particularly preferably 0.05 to 20 wt.-%, energy transformation component (α), 5 to 60 wt.-%, particularly preferably 8 to 50 wt.-% volume expansion component (β), 35 to 94.95 wt.-%, particularly preferably 40 to 90 wt.-% and quite particularly preferably 49 to 90 wt.-% binder (γ).

Unless otherwise indicated, all quantities are relative to the total mass of the support material.

The production of the ceramic or glass ceramic shaped parts is effected by a LIFT process as defined herein with the steps described above. The production of the green compact takes place in steps (1) to (4). By layered application of a ceramic slip to a receiver substrate, a ceramic green compact is produced, which is debinded in step (7). Here, the binder used is removed by heating the green compact to a temperature of preferably 90° C. to 600° C., and the so-called white body is obtained.

Steps (1) and (2) of the process are preferably carried out at room temperature. Particularly in the case of solid or paste-like slips, the printing process can advantageously also be carried out at increased temperature, for example in that the coated carrier is heated in step (1) and/or (2), preferably to approx. 50° C.

According to a preferred embodiment of the process, the laser or the energy source is used not only to transfer the slip from the carrier substrate onto the receiver substrate but also to completely or partially remove the organic components contained in the slip material.

In step (7) the white body is sintered to form a dense ceramic shaped body. The sintering of the white body is effected in a sintering furnace, preferably at a temperature of from 650 to 1100° C., preferably 700 to 900° C., for glass ceramic, of from 1100 to 1600° C. for zirconia and of from 1200 to 1600° C., preferably 1250 to 1500° C., for aluminium oxide. The sintering is preferably effected in a vacuum. The risk of the formation of air inclusions and the processing time can hereby be reduced.

The ceramic shaped bodies produced using the process according to the invention are characterized by high strength and great detail accuracy. In the case of shaped bodies made of glass ceramic, the flexural strength according to ISO 6872 is preferably above 100 MPa, in particular in the range of from 150 to 500 MPa. Shaped bodies made of Al₂O₃ have a flexural strength preferably of over 300 MPa, in particular of from 500 to 1000 MPa, shaped bodies made of ZrO₂ of more than 500 MPa in particular of from 800 to 2500 MPa.

The slips according to the invention yield a high green body strength and high dimensional stability, accuracy and precision after the debinding, sintering and cleaning. During sintering a density of >99% of the theoretical density can be achieved without difficulty. Through the process according to the invention slips with a much higher viscosity can in particular also be processed than with conventional inkjet or stereolithography processes. In this way the content of ceramic and/or glass ceramic particles in the slip can be increased and the binder and dispersant content can be correspondingly reduced, with the result that the debinding is considerably accelerated and simplified and the problems associated with the dense sintering are largely avoided.

In contrast to conventional stereolithography processes, in the case of the process according to the invention different slips can be deposited in one layer. In this way it is possible, for example, to produce dental restorations stained at selected locations. In addition, compared with conventional stereolithographic processes the debinding is much quicker and less prone to error. In the case of the process according to the invention the individual layers already dry at least partially during the printing process, with the result that the diffusion paths for the evaporation of the low-boiling portions are short. Moreover, pores form here which make it easier for dispersant and binder components as well as decomposition products to escape during the debinding and sintering. In contrast, the green compacts obtained in the case of conventional stereolithography do not have any pores in early phases of the debinding, with the result that the debinding has to be effected very carefully and slowly.

The invention is explained in more detail in the following with reference to examples.

### EXAMPLES

### Example 1

Aqueous ZrO₂ Slip

3.15 g dispersant (Dolapix CE64, from Zschimmer & Schwarz) and 1.5 g tetramethylammonium hydroxide were dissolved one after the other in 194.4 g distilled water. The solution had a pH of 10-10.5. This solution was then placed in the storage tank of an agitator bead mill (MicroCer agitator bead mill, from Netzsch), the grinding chamber and rotor of which consist of zirconium oxide. The grinding chamber was filled with 60 ml zirconium oxide grinding beads with a diameter of 0.2-0.3 mm (from Tosoh). At a rotational speed of the rotor of 1500 rpm, the solution was continuously pumped through the grinding chamber using a peristaltic pump (tube internal diameter 8 mm). 630 g zirconium oxide powder which was partially stabilized with 3 mol.-% Y₂O₃ (primary particle size: 40 nm; TZ-PX-245) was then added to the solution in the storage tank, continuously and with stirring. Once the addition of the zirconium oxide powder was complete, the obtained mixture was pumped continuously through the grinding chamber and back into the storage tank for 45 min at a rate of approx. 40 l/h. The suspension prepared in this way was transferred into an external container for further processing and stirred very slowly with a magnetic stirrer in order to remove trapped air bubbles. One drop of a defoamer (Contraspum, from Zschimmer & Schwarz) was also added.

In the last step, PEG 20,000 was added and homogenized for a further 1-2 hours. A slip with the following composition was obtained:

| Proportion [wt.-%] | Component |
|---|---|
| 78.04% | ZrO₂, stabilized with 3 mol.-% Y₂O₃ |
| | (TZ-PX-245) |
| 0.16% | Tetramethylammonium hydroxide (TMAH) |
| 1.96% | PEG 20,000 |
| 0.39% | Dispersant |
| | (Dolapix CE64, from Zschimmer&Schwarz) |
| 19.45% | Deionized water (dispersant) |

Unless otherwise indicated, all percentages in the examples are percentages by weight.

### Example 2

Aqueous ZrO₂ slip

In the manner described in Example 1 a slip with the following composition was prepared:

| Proportion [wt.-%] | Component |
|---|---|
| 80.95% | ZrO₂, stabilized with 3 mol.-% Y₂O₃ |
| | (TZ-PX-245) |
| 0.05% | 2-[2-(2-Methoxyethoxy)ethoxy]acetic |
| | acid (TODA) |
| 5% | PEG 10,000 |
| 0.1% | Safranin O (CAS 477-73-6) |
| 2% | Glycerol |
| 11.9% | Deionized water (dispersant) |

### Example 3

Aqueous ZrO₂ slip (for a red shade)

In the manner described in Example 1 a slip with the following composition was prepared:

| Proportion [wt.-%] | Component |
|---|---|
| 78.04% | ZrO₂, stabilized with 9.2 wt.-% Er₂O₃ |
| | (TZ-PX-389) |
| 0.16% | Tetramethylammonium hydroxide (TMAH) |
| 1.96% | PEG 1,500 |
| 0.39% | Dispersant |
| | (Dolapix CE64, from Zschimmer&Schwarz) |
| 19.45% | Deionized water, dispersant |

### Example 4

Aqueous ZrO₂ Slip (for a Yellow Shade)

In the manner described in Example 1 a slip with the following composition was prepared:

| Proportion [wt.-%] | Component |
|---|---|
| 78.04% | ZrO₂, stabilized with 5.33 wt.-% Y₂O₃ and |
| | an Fe₂O₃ content of 0.150 wt.-% (TZ-PX- |
| | 364) |
| 0.16% | Tetramethylammonium hydroxide (TMAH) |
| 1.96% | PEG 6,000 |
| 0.39% | Dispersant |
| | (Dolapix CE64, from Zschimmer&Schwarz) |
| 19.45% | Deionized water (dispersant) |

The slips described in Examples 1, 3 and 4 can be mixed with each other before the printing to set the desired colour shade.

### Example 5

Lithium Disilicate Slip

A slip with the composition indicated in the following table was prepared.

| Component | Proportion [wt.-%] |
|---|---|
| Lithium disilicate glass ceramic | 75% |
| (e.max Transpa; from Ivoclar Vivadent, | |
| Liechtenstein), ground, D50 = 3 μm | |
| Solplus D540 (CAS 1000871-74-8; Lubrizol) | 1% |
| Poly(ethylene glycol) 10,000 g/mol | 2% |
| Poly(ethylene glycol) 200 g/mol | 5% |
| Propylene glycol diacetate | 10.8% |
| Methyl ethyl ketone | 6% |
| Sudan Black B (CAS 4197-25-5) | 0.2% |

For this, the listed components were weighed out. The total weight of the slips was 100 grams. Then they were homogenized in a mixer (Speedmixer DAC 400fvz, from Hauschild) five times for 2 min each time at 2750 rpm. Between the homogenization steps there was a wait of 5-10 minutes in each case in order to allow the material to cool down again. The slip is solid, paste-like and storage stable at 25° C. Through strong shearing or heating to above 50° C. it becomes liquid again and easily processable.

### Example 6

Production of Shaped Bodies with a LIFT Process

The slips from Examples 1 to 4 were applied to a plasma-treated 50-μm-thick PET film (carrier) in each case separately using a doctor blade. The material film thickness was 30 μm in all cases. The slip from Example 5 was applied by scraper in the heated state of 50° C. and processed.

The carrier substrates were then transferred into the working area of the laser and processed there within a maximum of 5 seconds. A neodymium:YAG laser with a wavelength of 1064 nm was used as laser. The coated carriers were fired at from behind through the carrier substrate with a laser pulse of 100 ns with a power of 12 mW, wherein the laser beam was focused on a spot with a diameter of 50 μm. Plasma-treated PET films with a thickness of 50 μm were used as receiver substrate. The droplets were deposited on the receiver substrate next to each other with an overlap of 0-30 μm, while the material film was continuously renewed. The distance between carrier substrate (site of droplet generation, i.e. the point at which the laser fires the droplets from the material layer) and receiver substrate was 300 μm.

Slips 1-5 were dried on the receiver substrate with a constant airflow over the receiver substrate within 10 seconds until they solidify.

The support material was deposited on the receiver substrate at selected locations. The slip was applied in the described manner in the free spaces not printed with support material. In a first series, in each case one of the slips described in Examples 1 to 5 was used for the production of a component. In a second series of tests, the slips 1 to 4 were combined and deposited next to each other in a chessboard pattern in order to obtain a component stained at selected locations. The slips were solidified by drying. In each case 5 layers of support material and 5 layers of construction material were deposited, then the component was smoothed to match the layer heights using a tungsten carbide burr with material suction. After the smoothing, further layers were applied and smoothed again. The procedure was repeated until the printing of the object was finished.

The support material used had the following composition:

| Component | Proportion | |
|---|---|---|
| Deionized water | 49.80 | wt.-% |
| Polyethylene glycol 2,000 g/mol | 50 | wt.-% |
| Safranin O (CAS 477-73-6) | 0.20 | wt.-% |

After completion of the printing process, the printed objects, which were completely surrounded by the support material, were placed in a sintering furnace and heated there at a heating rate of +1° C./min from room temperature to 500° C. During the heating, the support material melted and flowed out of the printed objects.

The objects were then able to expand slightly at first and then contract without resistance during the debinding and sintering. Delicately adhering support material residues and the receiver substrate (PET film) decomposed residue-free in the further heating process. The green bodies were then debinded completely and were able to be densely sintered.

Objects made of the slips of Examples 1-4 (ZrO₂) were heated at a heating rate of +10° C./min to 1500° C. and then sintered at 1500° C. for 1 hour.

Objects made of the slip according to Example 5 (lithium disilicate slip) were heated from 500° C. in a vacuum at 10° C./min to 700° C., held there for 30 min, then heated at +10° C./min to 850° C., held there for 10 minutes, then cooled down in a controlled manner at −10° C./min to 700° C. and thereafter cooled down further in an uncontrolled manner.

After cooling to room temperature, 3D printed parts made of ceramic were obtained. The tests show that the process according to the invention and the slips according to the invention are particularly suitable for producing dental restorations and ceramic shaped parts stained at selected locations. The crown-shaped ceramic components had no debinding cracks, were optically homogeneous and had a density of more than 99.5% of the theoretical density. The density was measured according to Archimedes' principle.

1. A slip for the production of ceramic or glass ceramic shaped parts for energy pulse-induced transfer printing (LIFT), comprising
(a) ceramic and/or glass ceramic particles,
(b) at least one binder,
(c) at least one energy transformation component and
(d) at least one dispersant.

2. The slip according to claim 1, comprising as component (a) ceramic particles based on ZrO₂, Al₂O₃ or ZrO₂—Al₂O₃, or based on ZrO₂, Al₂O₃, ZrO₂⁻Al₂O₃ which is stabilized in each case with CaO, Y₂O₃, La₂O₃, CeO₂ and/or MgO, or based on ZrO₂ spinel, ZrO₂—Al₂O₃ spinel, a spinel of the AB₂O₄, AB₁₂O₁₉, AB₁₁O₁₈, AB₂O₄ type, wherein A is an alkali metal or alkaline earth metal ion and B is a transition metal ion which has a higher oxidation state than A.

3. The slip according to claim 2, in which the ceramic particles additionally comprise Er₂O₃, Fe₂O₃, Co₃O₄, MnO₂, NiO₂, Cr₂O₃, Pr₂O₃, Tb₂O₃ and/or Bi₂O₃ as chromophoric component.

4. The slip according to claim 1, which comprises as component (a) glass ceramic particles based on leucite, apatite and/or lithium disilicate glass ceramic.

5. The slip according to claim 1, which comprises as binder (b) a binder which is not radically polymerizable and which in pure form is solid at 25° C.

6. The slip according to claim 5, which comprises as binder (b) a cellulose derivative, methylcellulose, hydroxyethyl cellulose, hydroxypropyl methylcellulose, hydroxybutyl methylcellulose and/or sodium carboxymethyl cellulose, poly(vinyl alcohol) (PVA), poly(vinyl acetate) (PVAc), poly(vinylpyrrolidine) (PVP), poly(acrylic acid) (PAA), a copolymer of acrylic acid ester and acrylic acid (AE/AA), poly(ethyl acrylate) (PEA), poly(methacrylic acid) (PMAA), poly(methyl methacrylate) (PMMA), ammonium polyacrylate (NH4PA), ammonium poly(methacrylate) or poly(ethylene glycol) (HO—(CH₂CH₂O)ₙ—OH).

7. The slip according to one of claim 1, which comprises as energy transformation component (c) an inorganic or organic dye or an inorganic or organic pigment.

8. The slip according to claim 1, which comprises as dispersant (d) a solvent with a boiling point of less than 200° C. (under standard pressure) comprising one or more of triethyl 2-acetylcitrate, acetic acid butyl ester, acetic acid n-hexyl ester, 1-octanol, propylene glycol diacetate, ethylene glycol diacetate, acetone, methyl ethyl ketone (MEK), isopropanol, ethanol, butanol, p-xylene, cyclohexanone, butyl acetate, hexyl acetate and water.

9. The slip according to claim 8, in which the dispersant additionally comprises a solvent with a boiling point of over 200° C. (under standard pressure) comprising one or more of PEG (average molecular weight <600 g/mol), glycerol and 1,2-propanediol.

10. The slip according to claim 1, which additionally comprises at least one additive which is selected from stabilizers, biocides, parabens, rheology modifiers and/or fragrances.

11. The slip according to claim 1, which comprises
35 to 90 wt.-% ceramic and/or glass ceramic particles (a),
0.0 to 10 wt.-% binder (b);
0.000 to 2 wt.-% energy transformation component (c);
9 to 50 wt.-% dispersant (d),
in each case relative to the total mass of the slip.

12. The slip according to claim 1, which comprises
50 to 88 wt.-% ceramic and/or glass ceramic particles (a),
0.2 to 7 wt.-% binder (b);
0.001 to 1 wt.-% energy transformation component (c);
11 to 40 wt.-% dispersant (d), in each case relative to the total mass of the slip.

13. The slip according to claim 1, which comprises
60 to 85 wt.-% ceramic and/or glass ceramic particles (a),
0.5 to 5 wt.-% binder (b);
0.01 to 0.5 wt.-% energy transformation component (c);
14 to 30 wt.-% dispersant (d), in each case relative to the total mass of the slip.

14. A process of using the slip according to claim 1 for the production of ceramic or glass ceramic shaped parts, comprising a dental restoration, inlay, onlay, veneer, crown, bracket, bridge, framework, abutment or implant, by energy pulse-induced transfer printing (LIFT).

15. A process for the additive manufacture of a ceramic or glass ceramic shaped part which comprises the following steps:
(1) laminar application of a slip to a carrier in a defined layer thickness,
(2) transfer of a portion of the slip from the carrier substrate (donor) onto a receiver substrate (acceptor) by the local input of an energy pulse, at selected locations,
(3) solidifying the slip on the receiver substrate,
(4) repetition of steps (1)-(3) in order to obtain a green compact,
(5) optionally removal of the support material from the green compact and optional cleaning of the green compact,
(6) optional post-tempering of the green compact by further curing,
(7) heat treatment of the green compact to remove the non-ceramic constituents (debinding), in order to obtain a white body, and sintering the white body to form a ceramic object,
characterized in that the slip according to claim 1 is used.

16. The process according to claim 15, wherein:
(1) the defined layer thickness is 3-300 μm or 10-100 μm,
(2) the energy pulse comprises a laser pulse,
(3) solidifying comprises drying, radiation curing or altering the aggregation state, and
(6) further curing comprises by drying, radiation, heat or a combination thereof.

17. The process according to claim 15, in which the slip is smoothed following step (3), with a roller, blade, burr and/or a wiper.

18. The process according to claim 15, in which in step (2) a support material is additionally applied to the receiver substrate.

19. The process according to claim 15, in which a polymer film, a glass carrier, a carrier made of a non-metallic, inorganic, non-porous material, a metallic carrier or a ceramic carrier is used as carrier in step (1) and/or as receiver substrate in step (2).

20. The process according to claim 15, in which the energy pulse in step (2) is effected via the side of the carrier substrate facing away from the slip.
